(19) United States
(12) Patent Application Publication
(10) Pub. No.: US 2010/0032992 A1
(43) Pub. Date: Feb. 11, 2010

(54) SUNSHADE ASSEMBLY AND OPEN ROOF CONSTRUCTION PROVIDED THEREWITH

(75) Inventor: Dave Keller, Ortonville, MI (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: Inalfa Roof Systems Group B.V., Venray (NL)

(21) Appl. No.: 12/186,876

(22) Filed: Aug. 6, 2008

(51) Int. Cl. B60J 7/06; E06B 9/40; A47G 5/02; E06B 9/42; E06B 9/68

(52) U.S. Cl. 296/216.01; 160/267.1; 160/265

(57) ABSTRACT

A sunshade assembly comprises a flexible sunscreen having opposed longitudinal edges and opposed transversal edges, two opposed longitudinal guides for receiving therein and guiding corresponding ones of the opposed longitudinal edges of the sunscreen, a rotatable winding shaft configured for winding an unwinding the sunscreen at first one of its transversal edges, and an operating beam connected to the second one of the transversal edges of the sunscreen. Each of the opposed longitudinal edges of the sunscreen near to the second one of the transversal edges is provided with a wing folded inwards around a positioning member having a stationary position relative to said second transversal edge and extending into a corresponding one of said opposed longitudinal guides.

### BACKGROUND

The discussion below is merely provided for general background information and is not intended to be used as an aid in determining the scope of the claimed subject matter.

Aspects of the invention firstly relate to a sunshade assembly, comprising a flexible sunscreen, a rotatable winding shaft for winding and unwinding the sunscreen, and an operating beam connected to the sunscreen.

One important field of application of such sunshade assemblies are vehicles which are provided with open roof constructions having roof assemblies. Such sunshade assemblies may be integrated into such roof assemblies of open roof constructions during the construction of the vehicles, but also may be provided afterwards (in which case the vehicles are retrofitted with a so-called after market open roof construction).

A problem with such sunshade assemblies may occur when a longitudinal edge of the flexible sunscreen moves out of the corresponding longitudinal guide, for example by wind loads or by being pushed unintentionally by a user. Again moving said longitudinal edge into said longitudinal guide then may be a difficult task.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the background.

In accordance with an aspect of the present invention a sunshade assembly comprises a flexible sunscreen having opposed longitudinal edges and opposed transversal edges; two opposed longitudinal guides for receiving therein and guiding corresponding ones of the opposed longitudinal edges of the sunscreen; a rotatable winding shaft configured for winding and unwinding the sunscreen at a first one of its transversal edges; an operating beam connected to the second one of the transversal edges of the sunscreen; wherein each of the opposed longitudinal edges of the sunscreen near to the second one of the transversal edges is provided with a wing folded inwards around a positioning member having a stationary position relative to said second transversal edge and extending into a corresponding one of said opposed longitudinal guides.

As a result of such a wing folded inwards around said positioning member the longitudinal edges of the sunscreen remain more safely in the corresponding guides. Moreover, when a longitudinal edge is moved out of a corresponding guide, completely winding the sunscreen onto the winding shaft and thereafter unwinding it therefrom fully restores the correct position of the sunscreen, i.e. with its longitudinal edges received in the corresponding guides.

In any unwound or partially unwound position the sunscreen at each of its longitudinal edges comprises a transitional area of the wing from the folded configuration near to the second transversal edge (near to the operating beam) towards a flat configuration closer to the winding shaft. When the sunscreen is wound onto the winding shaft it will flatten shortly before reaching said winding shaft.

It is noted that the phrase “folded inwards” does not necessarily mean that the inwardly folded part of the sunscreen rests upon or engages the unfolded part of the sunscreen.

In an embodiment the longitudinal guides each comprise two guide channels positioned one above the other, and wherein each positioning member extends in a first one of said two guide channels, whereas the operating beam comprises opposite lateral ends each extending into a corresponding second one of said two guide channels.

For example it is possible that each positioning member extends in a lower one of said two guide channels, whereas each of the lateral ends of the operating beam extends into a corresponding upper one of said two guide channels.

Further it is possible that said positioning member is connected to the operating beam in a releasable manner, for example when the positioning member together with the operating beam defines a snap connection.

It should be noted, however, that also other constructive features could be applied with which a releasable connection between the positioning member and operating beam may be realised. Such other types may be of a type being operated manually, or of a type needing some tool to be operated.

In still another embodiment the sunshade assembly comprises two longitudinal drive members housed in said longitudinal guides engaging opposite lateral ends of the operating beam and capable of a reciprocating movement in said guides.

In an embodiment of the sunshade assembly each longitudinal edge of the sunscreen is folded inwards such that the folded part thereof is positioned above the unfolded part thereof. Such a configuration may improve the tendency of the sunscreen to flatten out when reaching the winding shaft.

The invention secondly relates to an open roof construction or roof assembly kit for a vehicle having an opening in a stationary roof. The kit comprises a movable closure panel configured for opening and closing said roof opening and a sunshade assembly having one or more features herein described.

### BRIEF DESCRIPTION OF THE DRAWINGS

Hereinafter the invention will be elucidated while referring to the drawing, in which:

FIG. 1 shows, schematically and in a perspective view, a sunshade assembly applied to an open roof construction;

FIG. 2 shows, schematically and in a transverse cross section, a detail of the sunshade assembly; and

FIG. 3 shows, schematically and in a perspective view, a part of the sunshade assembly for illustrating its operation.

### DETAILED DESCRIPTION OF THE ILLUSTRATIVE EMBODIMENT

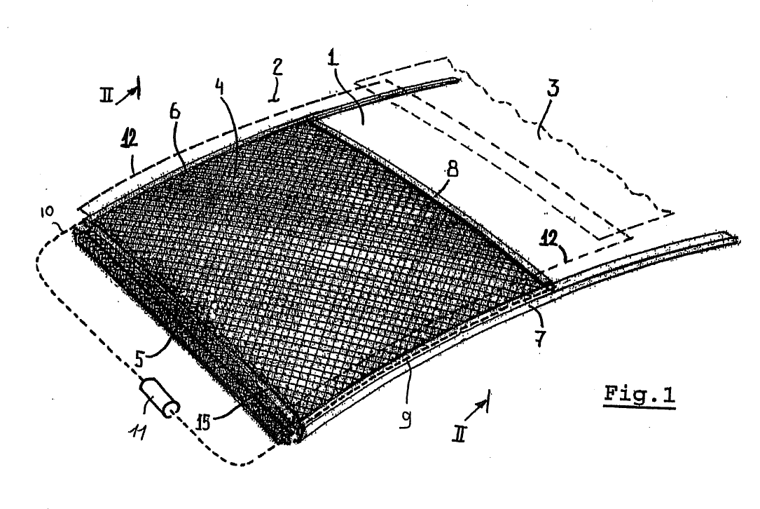

Firstly referring to FIG. 1, an open roof construction having a roof assembly for a vehicle (schematically represented by a stationary roof 2) is illustrated schematically. Said roof assembly is for opening and closing a roof opening 1 in a stationary roof part 2 of the vehicle and includes a movable closure panel 3 which, by means not illustrated in detail but known per se, can be moved for opening and closing said roof opening 1. Commonly, as is known, the movable panel 3 is guided in longitudinal guides mounted in or formed in the stationary roof part 2 along longitudinal sides 12 of the roof opening 1. A user operated device such as a motor or crank (not illustrated) is operably coupled to the panel 3 via cables or the like to move the panel 3 selectively between its open and closed positions. In FIG. 1 the closure panel 3 has been illustrated in a position in which it opens the roof opening 1.

Below the roof opening 1 a sunshade assembly is positioned. Basically, said sunshade assembly comprises a flexible sunscreen 4, a rotatable winding shaft 5 for winding and unwinding the sunscreen 4 at a first transversal edge and two opposite longitudinal guides 6 and 7. The guides 6, 7 can be connected to or formed integral from a single unitary body with the guides of the closure panel (not illustrated). Likewise, the guides 6, 7 can be separate from the guides of the panel, in which case the open roof construction comprises a kit, the minimum of which does further includes the panel besides the sunshade assembly. Drive members may be provided, which in FIG. 1 have been illustrated schematically by dotted lines 9, 10. As is known per se, the drive members may comprise longitudinal members driven by an actuator 11 for a reciprocating movement for winding and unwinding the sunscreen 4.

Each drive member 9, 10 is connected to an operating beam 8 provided at and connected to a transversal edge of the sunscreen 4 remote from the winding shaft 5.

Although the reciprocating movement of the sunscreen 4 primarily is generated by the reciprocating movement of the drive members 9 and 10 as caused by the actuator 11, it is possible too that in addition the winding shaft 5 is preloaded in a sense for winding the sunscreen 4 thereon. Further it should be noted that the movement of the sunscreen also may be initiated manually.

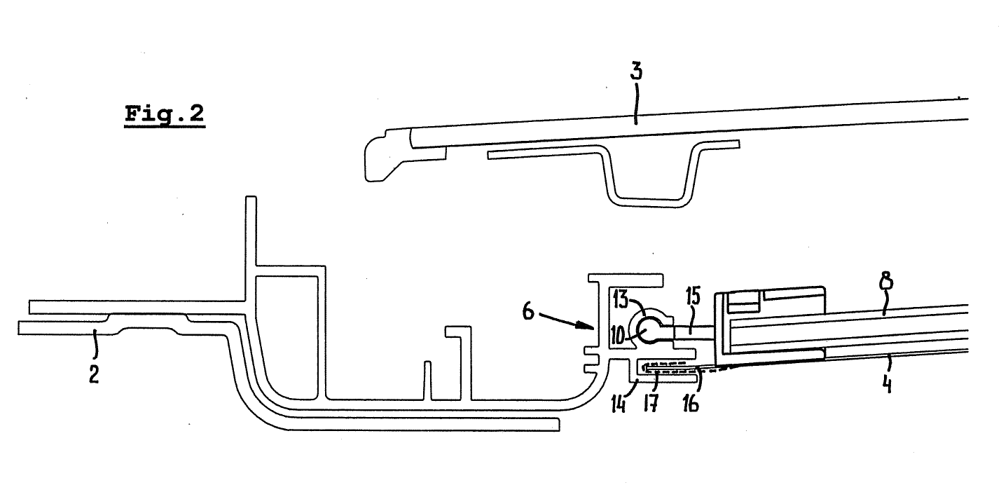

Now, reference is made to FIG. 2 which schematically illustrates a transverse cross section according to II-II in FIG. 1 (it is noted that only the left half of the cross section is shown, the right half being a mirror image thereof).

FIG. 2 shows the panel 3, left guide 6 (attached to the stationary roof part 2) and operating beam 8. The sunscreen 4 is attached to the operating beam 8 in a manner known and not further elucidated here.

The guide 6 comprises an upper guide channel 13 and a lower guide channel 14. The operating beam 8 has attached to its outer end a mounting part 15 which protrudes into the upper guide channel 13 and which is connected therein to drive member (e.g. cable) 10. Thus, the operating beam 8 comprises opposite lateral ends each extending into a corresponding upper guide channel 13 and being guided therein.

The corresponding longitudinal edge of the sunscreen 4 will be guided in the lower guide channel 14.

It is noted that the mounting part 15 may or may not protrude fully into the guide channel 13, basically depending upon the shape of the guide channel 13 and the shape of the mounting part 15. Thus, the phrase “extending into a corresponding upper guide channel” has to be taken not too literally.

A positioning member 16 is attached to the operating beam in a manner to be described later, and extends into, and is guided by, lower guide channel 14. As indicated by a dotted line, a wing 17 of the sunscreen 4 is folded around said positioning member 16. This wing 17 may be an integral part (transverse prolongation such as being formed from a single unitary body) of the sunscreen 4 or may be a separate part attached to the sunscreen in any appropriate manner (e.g. stitching, gluing etc). In the illustrated embodiment the positioning member 16 is embodied as a lip.

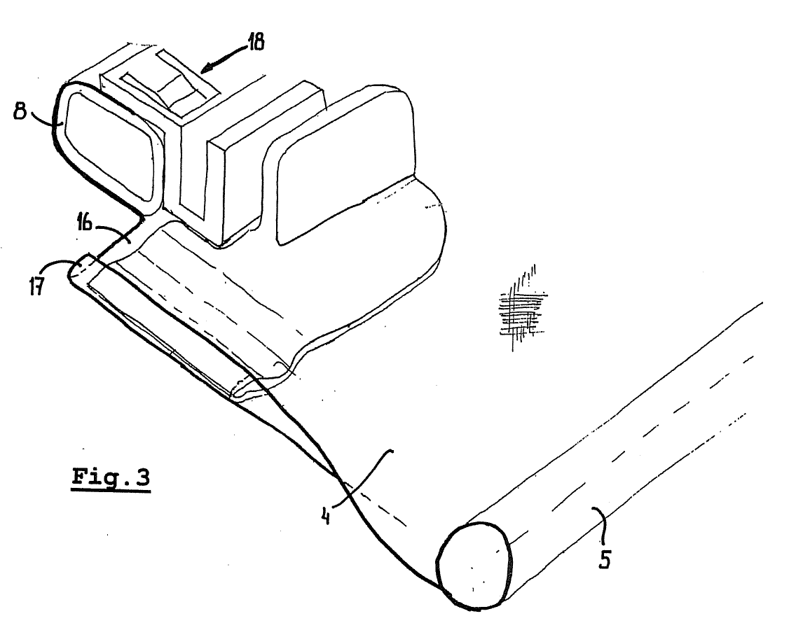

Referring to FIG. 3, part of the operating beam 8 near its left end is shown. Its mounting part 15 has been omitted in this view. The guide 6 with upper guide channel 13 and lower guide channel 14 also has been omitted in this view to more clearly show the positioning member or lip 16.

The positioning member 16 is attached to the operating beam 8 through a snap connection (generally indicated by reference 18). Thus a releasable connection between the operating beam 8 and positioning member 16 is created (e.g. for making assembly/disassembly of these parts, and thus the sunshade assembly, easier). However, in another embodiment, the positioning member 16 can be integral with the operating beam 8 being formed from a single unitary body.

From FIG. 3 it appears that the wing 17 of the sunscreen 4 gradually unfolds in a direction towards the winding shaft.

When, in a fully or partially closed position of the sunscreen 4 a longitudinal edge thereof comes out of the lower guide channel 14, the position thereof can be restored by fully opening the sunscreen (winding it onto the winding shaft 5) and again moving it to a (partially) closed position. The wing 17 extending around the lip 16 will take care of again positioning the longitudinal edge of the sunscreen into the corresponding lower guide channel 14.

Although the subject matter has been described in a language specific to structural features and/or methodological acts, it is to be understood that the subject matter defined in the appended claims is not necessarily limited to the specific features or acts described above as has been determined by the courts. Rather, the specific features and acts described above are disclosed as example forms of implementing the claims.

What is claimed is:

1. A sunshade assembly comprising:
a flexible sunscreen having opposed longitudinal edges and opposed transversal edges;
two opposed longitudinal guides for receiving therein and guiding corresponding ones of the opposed longitudinal edges of the sunscreen;
a rotatable winding shaft configured for winding and unwinding the sunscreen at a first one of its transversal edges;
an operating beam connected to the second one of the transversal edges of the sunscreen;
wherein each of the opposed longitudinal edges of the sunscreen near to the second one of the transversal edges is provided with a wing folded inwards around a positioning member having a stationary position relative to said second transversal edge and extending into a corresponding one of said opposed longitudinal guides.

2. The sunshade assembly according to claim 1, wherein the longitudinal guides each comprise two guide channels positioned one above the other, and wherein each positioning member extends in a first one of said two guide channels, whereas the operating beam comprises opposite lateral ends each extending into a corresponding second one of said two guide channels.

3. The sunshade assembly according to claim 2, wherein each positioning member extends in a lower one of said two guide channels, whereas each of the lateral ends of the operating beam extends into a corresponding upper one of said two guide channels.

4. The sunshade assembly according to claim 1, wherein said positioning member comprises a lip projecting into the corresponding guide and wherein the corresponding wing of the longitudinal edge of the sunscreen is folded around said lip.

5. The sunshade assembly according to claim 1, wherein said positioning member is connected to the operating beam in a releasable manner.

6. The sunshade assembly according to claim 5, wherein the positioning member together with the operating beam defines a snap connection.

7. The sunshade assembly according to claim 1, wherein said positioning member is an integral part of the operating beam being formed from a single unitary body.

8. The sunshade assembly according to claim 1, comprising two longitudinal drive members housed in said longitudinal guides engaging opposite lateral ends of the operating beam and capable of a reciprocating movement in said guides.

9. The sunshade assembly according to claim 1, wherein each longitudinal edge of the sunscreen is folded inwards such that the folded part thereof is positioned above the unfolded part thereof.

10. The sunshade assembly according to claim 1, wherein the wing is an integral prolongation of the sunscreen.

11. The sunshade assembly according to claim 1, wherein the wing is a separate part attached to the sunscreen.

12. A roof assembly kit for a vehicle having an opening in a stationary roof, the kit comprising:
a movable closure panel configured for opening and closing said roof opening; and
a sunshade assembly comprising:
a flexible sunscreen having opposed longitudinal edges and opposed transversal edges;
two opposed longitudinal guides for receiving therein and guiding corresponding ones of the opposed longitudinal edges of the sunscreen;
a rotatable winding shaft configured for winding and unwinding the sunscreen at a first one of its transversal edges;
an operating beam connected to the second one of the transversal edges of the sunscreen;
wherein each of the opposed longitudinal edges of the sunscreen near to the second one of the transversal edges is provided with a wing folded inwards around a positioning member having a stationary position relative to said second transversal edge and extending into a corresponding one of said opposed longitudinal guides.

13. The roof assembly kit for a vehicle according to claim 12, wherein the longitudinal guides each comprise two guide channels positioned one above the other, and wherein each positioning member extends in a first one of said two guide channels, whereas the operating beam comprises opposite lateral ends each extending into a corresponding second one of said two guide channels.

14. The roof assembly kit for a vehicle according to claim 13, wherein each positioning member extends in a lower one of said two guide channels, whereas each of the lateral ends of the operating beam extends into a corresponding upper one of said two guide channels.

15. The roof assembly kit for a vehicle according to claim 12, wherein said positioning member comprises a lip projecting into the corresponding guide and wherein the corresponding wing of the longitudinal edge of the sunscreen is folded around said lip.

16. The roof assembly kit for a vehicle according to claim 12, wherein said positioning member is connected to the operating beam in a releasable manner.

17. The roof assembly kit for a vehicle according to claim 16, wherein the positioning member together with the operating beam defines a snap connection.

18. The roof assembly kit for a vehicle according to claim 12, wherein said positioning member is an integral part of the operating beam being formed from a single unitary body.

19. The roof assembly kit for a vehicle according to claim 12, comprising two longitudinal drive members housed in longitudinal guides engaging opposite ends of the operating beam and capable of a reciprocating movement in said guides.

20. The roof kit for a vehicle according to claim 12, wherein each longitudinal edge of the sunscreen is folded inwards such that the folded part thereof is positioned above the unfolded part thereof.

21. The roof assembly kit for a vehicle according to claim 12, wherein the wing is an integral prolongation of the sunscreen being formed from a single unitary body.

22. The roof assembly kit for a vehicle according to claim 12, wherein the wing is a separate part attached to the sunscreen.
